(19) United States
(12) Patent Application Publication
(10) Pub. No.: US 2011/0244365 A1
(43) Pub. Date: Oct. 6, 2011

(54) METAL OXIDE-YTTRIA STABILIZED ZIRCONIA COMPOSITE AND SOLID OXIDE FUEL CELL USING THE SAME

(76) Inventors: Han Wool RYU, Gyunggi-do (KR); Jae Hyuk Jang, Seoul (KR); Chang Sam Kim, Seoul (KR); Sung Woon Jeon, Busan (KR)

(21) Appl. No.: 12/790,685

(22) Filed: May 28, 2010

(30) Foreign Application Priority Data
Mar. 30, 2010 (KR) 10-2010-0028670

(51) Int. Cl. H01M 8/10; H01M 4/86

(52) U.S. Cl. 429/489; 252/182.1

(57) ABSTRACT

Disclosed is a metal oxide-yttria stabilized zirconia composite, including 25˜75 wt % of a metal oxide-3 mol % yttria stabilized zirconia composite, and 75˜25 wt % of a metal oxide-8 mol % yttria stabilized zirconia composite. A solid oxide fuel cell is also provided, which includes the metal oxide-yttria stabilized zirconia composite as an anode layer or a support layer of an anode layer.

### CROSS REFERENCE TO RELATED APPLICATION

This application claims the benefit of Korean Patent Application No. 10-2010-0028670, filed Mar. 30, 2010, entitled “Metal oxide-yttria stabilized zirconia composite and solid oxide fuel cell using them”, which is hereby incorporated by reference in its entirety into this application.

### BACKGROUND OF THE INVENTION

1. Technical Field

The present invention relates to a metal oxide-yttria stabilised zirconia composite and a solid oxide fuel cell using the same.

2. Description of the Related Art

Among fuel cells, solid oxide fuel cells (SOFCs), which operate at the highest temperature (700˜1000° C.) and use as an electrolyte a solid oxide which is oxygen- or hydrogen-ion conductive, are advantageous because all constituents thereof are made of solids, thus attaining a simpler configuration compared to other fuel cells, obviating the need for a noble metal catalyst and facilitating supplying fuel thanks to direct internal reforming, without problems of loss, addition and corrosion of the electrolyte. Furthermore, an SOFC enables combined heat and power generation using waste heat because hot gas is emitted. Hence, thorough research into SOFCs is being conducted in the developed countries, including the USA and Japan, in order to achieve commercialization in the early 21^{st} century.

Typically, an SOFC includes an electrolyte layer having high oxygen-ion conductivity, and a cathode layer and an anode layer which are porous and disposed at both surfaces of the electrolyte layer.

In accordance with the operating principle of the SOFC, the SOFC typically generates power by the oxidation of hydrogen and carbon monoxide, and at its anode and cathode layers there occur the reactions represented by Reaction 1 below.

Anode: H₂+O²⁻→H₂O+2e⁻,

CO+O²⁻→CO₂+2e⁻

Cathode: O₂+4e⁻2O²⁻

Overall Reaction: H₂+CO+O₂→H₂O+CO₂ Reaction 1

Specifically, oxygen passes through the porous cathode layer to reach the electrolyte layer, after which oxygen is delivered to the anode layer via the electrolyte layer, wherein oxygen ions resulting from the reduction of oxygen are dense, so that it reacts with hydrogen supplied to the porous anode layer, thereby producing water. As such, because electrons are produced at the anode layer and used at the cathode layer, these two electrodes are connected to each other and electric current flows.

The importance of such a fuel cell lies in that gas permeability based on the porosity of the porous cathode and anode layers through which oxygen and hydrogen pass is increased, so that cell efficiency is improved. However, there arises the problem of the strength of the anode layer being decreased proportionally to the porosity thereof. The decreased strength of the anode layer shortens the mechanical lifetime of the fuel cell, which is regarded as a problem which will be overcome in unit cells of fuel cells which should ensure long-term durability of at least 40,000 hours.

The conventional SOFC mainly adopts an anode-supported SOFC for reasons of strength and financial benefits. Because such an anode-supported SOFC causes an electrochemical reaction in about 90% at the interface between the anode layer and the electrolyte layer, the anode layer is divided into a layer (functional layer) responsible for functionality and a layer (support layer) providing support.

As such, the support layer is made of yttria stabilized zirconia containing 8 mol % yttria (Y₂O₃), in order to maintain electrical conductivity and porosity at or above predetermined levels.

However, the support layer is thickened so that the strength of the support layer is maintained at or above a predetermined level. This is because the yttria stabilized zirconia containing 8 mol % yttria (Y₂O₃) has high oxygen-ion conductivity but has strength about four times lower than that of yttria stabilized zirconia containing 3 mol % yttria.

### SUMMARY OF THE INVENTION

Accordingly, the present invention has been made keeping in mind the problems encountered in the related art and the present invention is intended to provide a metal oxide-yttria stabilized zirconia composite suitable for use in an anode layer or a support layer of an anode layer in an SOFC, which has high porosity as in conventional yttria stabilized zirconia, and is able to reduce the thickness of the support layer while exhibiting superior strength.

This metal oxide-yttria stabilized zirconia composite may be utilized in the anode layer or the support layer of the anode layer in the SOFC, and includes a predetermined amount of yttria stabilized zirconia containing 3 mol % yttria (Y₂O₃) which has low oxygen-ion conductivity but high mechanical strength, in order to enhance the strength of yttria stabilized zirconia containing 8 mol % yttria (Y₂O₃) which is conventionally used for an anode layer.

Also the present invention is intended to provide an SOFC which includes the metal oxide-yttria stabilized zirconia composite having high strength and oxygen-ion conductivity as an anode layer or a support layer of an anode layer.

An aspect of the present invention provides a metal oxide-yttria stabilized zirconia composite, including 25˜75 wt % of a metal oxide-3 mol % yttria stabilized zirconia composite and 75˜25 wt % of a metal oxide-8 mol % yttria stabilized zirconia composite.

In this aspect, the metal oxide-yttria stabilized zirconia composite may include 45˜55 wt % of the metal oxide-3 mol % yttria stabilized zirconia composite and 55˜45 wt % of the metal oxide-8 mol % yttria stabilized zirconia composite.

In this aspect, the metal oxide of the metal oxide-yttria stabilized zirconia composite may be a nickel oxide or a copper oxide.

Another aspect of the present invention provides an SOFC, including an anode layer made of a metal oxide-yttria stabilized zirconia composite including 25˜75 wt % of a metal oxide-3 mol % yttria stabilized zirconia composite and 75˜25 wt % of a metal oxide-8 mol % yttria stabilized zirconia composite and having fuel gas permeability, an electrolyte layer formed on the anode layer, and a cathode layer which is formed on the electrolyte layer and which has oxygen gas permeability.

In this aspect, the metal oxide-yttria stabilized zirconia composite of the anode layer may include 45˜55 wt % of the metal oxide-3 mol % yttria stabilized zirconia composite and 55˜45 wt % of the metal oxide-8 mol % yttria stabilized zirconia composite.

In this aspect, the metal oxide of the metal oxide-yttria stabilized zirconia composite of the anode layer may be a nickel oxide or a copper oxide.

In this aspect, the anode layer may include a support layer and a functional layer which is formed on the support layer and which is in contact with the electrolyte layer, wherein the support layer may be made of a metal oxide-yttria stabilized zirconia composite including 25˜75 wt % of a metal oxide-3 mol % yttria stabilized zirconia composite and 75˜25 wt % of a metal oxide-8 mol % yttria stabilized zirconia composite, and the functional layer may be made of metal oxide-yttria stabilized zirconia.

The metal oxide-yttria stabilized zirconia composite of the support layer may include 45˜55 wt % of the metal oxide-3 mol % yttria stabilized zirconia composite and 55˜45 wt % of the metal oxide-8 mol % yttria stabilized zirconia composite.

### BRIEF DESCRIPTION OF THE DRAWINGS

The features and advantages of the present invention will be more clearly understood from the following detailed description taken in conjunction with the accompanying drawings, in which:

FIGS. 1 to 3 are SEM images showing a metal oxide-yttria stabilized zirconia composite according to an embodiment of the present invention;

FIG. 4 is a graph showing bending strength depending on the mol % of yttria of the yttria stabilized zirconia composite;

FIG. 5 is a graph showing bending strength depending on the weight ratio (wt %) of a metal oxide-3 mol % yttria stabilized zirconia composite and a metal oxide-8 mol % yttria stabilized zirconia composite in the metal oxide-yttria stabilized zirconia composite according to the embodiment of the present invention;

FIG. 6 is a graph showing fracture toughness depending on the weight ratio (wt %) of a metal oxide-3 mol % yttria stabilized zirconia composite and a metal oxide-8 mol % yttria stabilized zirconia composite in the metal oxide-yttria stabilized zirconia composite according to the embodiment of the present invention;

FIG. 7 is a cross-sectional view schematically showing an SOFC including the metal oxide-yttria stabilized zirconia composite as an anode layer, according to another embodiment of the present invention; and

FIG. 8 is a cross-sectional view schematically showing an SOFC including the metal oxide-yttria stabilized zirconia composite as a support layer of an anode layer, according to a further embodiment of the present invention.

### DESCRIPTION OF SPECIFIC EMBODIMENTS

Hereinafter, a detailed description will be given of embodiments of the present invention with reference to the accompanying drawings. Throughout the drawings, the same reference numerals refer to the same or similar elements, and redundant descriptions are omitted. Also in the description, in the case where known techniques pertaining to the present invention are regarded as unnecessary because they would make the characteristics of the invention unclear and also for the sake of description, the detailed descriptions thereof may be omitted.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

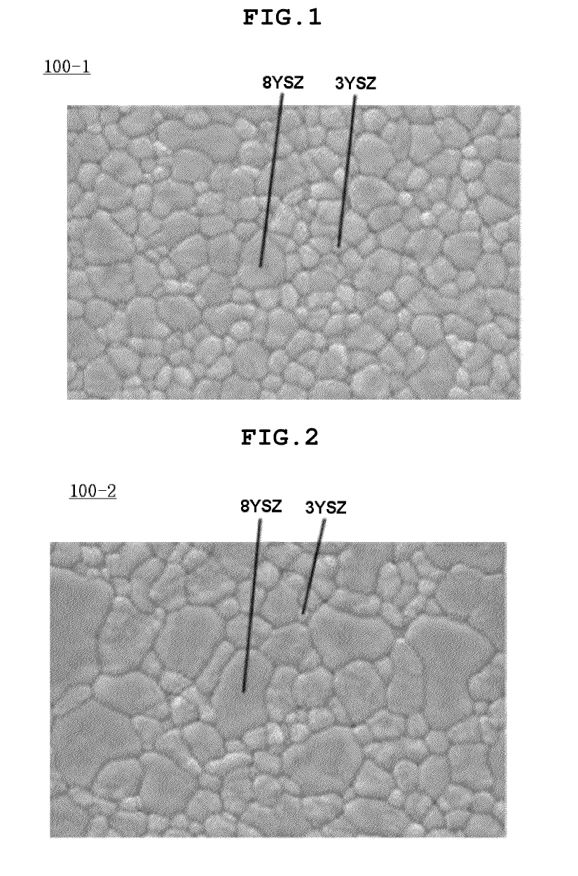

FIGS. 1 to 3 are SEM images showing a metal oxide-yttria stabilized zirconia composite according to an embodiment of the present invention.

With reference to these drawings, the metal oxide-yttria stabilized zirconia composite according to the present invention is descried below. The metal oxide-yttria stabilized zirconia composite according to the embodiment of the present invention includes 25˜75 wt % of a metal oxide-3 mol % yttria stabilized zirconia composite, and 75˜25 wt % of a metal oxide-8 mol % yttria stabilized zirconia composite.

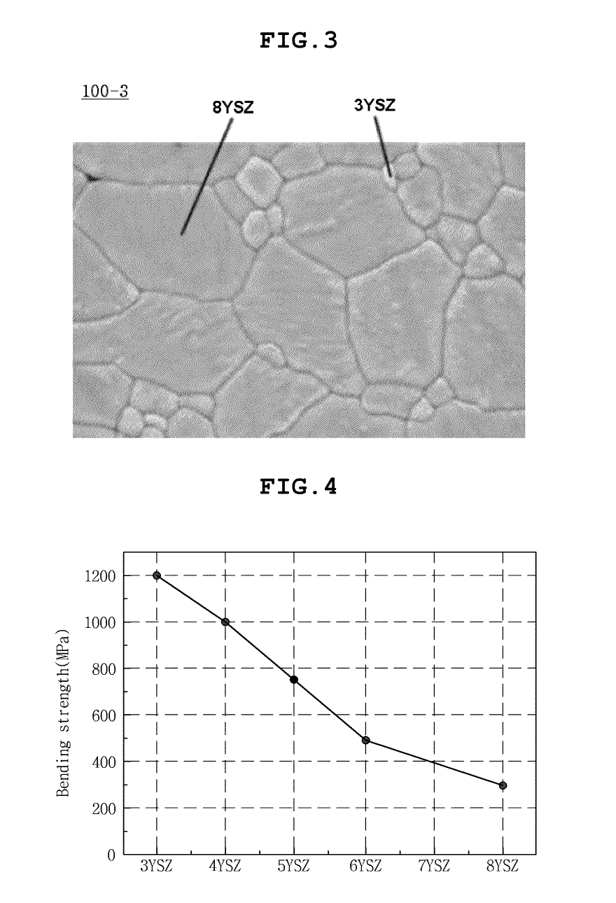

As shown in FIGS. 1 to 3, the metal oxide-yttria stabilized zirconia (hereinafter, referred to as “MO-YSZ”) composite includes metal oxide-3 mol % yttria stabilized zirconia (hereinafter, referred to as “MO-3YSZ”) and metal oxide-8 mol % yttria stabilized zirconia (hereinafter, referred to as “MO-8YSZ”) at a predetermined weight ratio. The MO-YSZ composite includes MO-3YSZ and MO-8YSZ at a weight ratio of 75 wt %:25 wt % in FIG. 1, and at weight ratios of 50 wt %:50 wt % and 25 wt %:75 wt % in FIGS. 2 and 3, respectively.

In FIG. 1, the composite includes a large amount of MO-3YSZ in a monoclinic phase and a small amount of MO-8YSZ in a cubic phase. Also, the amount of MO-8YSZ in a cubic phase increases in FIGS. 1, 2 and 3, in that order.

As shown in FIGS. 1 to 3, the MO-YSZ composite may be utilized in the anode layer or the support layer of the anode layer (which is regarded as an anode) in the SOFC.

In particular, in the case of an anode-supported SOFC, the anode layer should have mechanical properties appropriate as a support of a multilayered unit cell and simultaneously should satisfy electrochemical properties adapted for the oxidation of fuel, and furthermore, should be superior in terms of electrical conductivity or gas permeability, and should have a porous structure including pores so as to efficiently emit water vapor produced upon oxidation of fuel. The MO-YSZ composite according to the present invention, which includes MO-3YSZ and MO-8YSZ at a predetermined weight ratio satisfies the above properties.

The MO-YSZ composite according to the present invention is composed of metal oxide (MO) and yttria stabilized zirconia (YSZ).

In the MO-YSZ composite which has a porous structure, metal oxide (MO) has fuel catalytic activity and electronic conductivity, and yttria stabilized zirconia (YSZ) is an oxide which has ionic conductivity. As such, MO may include a transition metal oxide, in particular, a nickel oxide or a copper oxide, having high electronic conductivity.

In the composite, the weight ratio of MO and YSZ may be adjusted in consideration of mechanical strength, the coefficient of thermal expansion, electrical conductivity and gas permeability. For example, the weight ratio of MO and YSZ may fall in the range from 70 wt %:30 wt % to 50 wt %:50 wt %.

The MO-YSZ composite according to the embodiment of the present invention, in which MO and YSZ are used at the same (or equivalent) weight ratio, is formed of two MO-YSZ composites having different mol % amounts of yttria (Y₂O₃) added to YSZ.

Two such MO-YSZ composites include 3 mol % YSZ (hereinafter, referred to as “3YSZ”) and 8 mol % YSZ (hereinafter, referred to as “8YSZ”).

Briefly, the composite according to the present invention includes MO-3YSZ and MO-8YSZ.

The oxygen-ion conductivity of YSZ depends on the empty hole concentration of oxygen, and the strength thereof is based on the volume of YSZ increasing depending on changes in the mol % of yttria which is added to YSZ. For example, when a monoclinic phase is transformed into a tetragonal phase, the volume is increased by about 4.5% and the strength is reduced.

With reference to FIG. 4, the bending strength which depends on the mol % of yttria of YSZ is described below. As shown in FIG. 4, the bending strength can be seen to be linearly decreased in the middle between 3YSZ and 8YSZ. This is considered to be because t′-form tetragonal YSZ is mainly formed in the presence of yttria in an amount of about 4˜6 mol %.

The form of tetragonal YSZ varies depending on the mol % of yttria. Specifically, as the mol % of yttria increases, the tetragonal YSZ is present in t-form, t′-form, or t″-form. The t-form is present in YSZ containing yttria in an amount up to 3 mol %, called tetragonal YSZ that is possible to transform, and the t′-form is present in YSZ containing yttria in an amount up to 6.5 mol %, called tetragonal YSZ that is difficult to transform. The t″-form is present in YSZ containing 7 mol % yttria as tetragonal YSZ close to a cubic phase.

The YSZ present in a tetragonal phase in the wide range as above has reduced strength. When the amount of yttria is 8 mol % or less, a tetragonal phase and a cubic phase coexist. On the other hand, if the amount of yttria is above 8 mol %, the YSZ is present in a cubic phase.

Also, the empty hole concentration of oxygen is increased in proportion to the mol % of yttria, resulting in raised ionic conductivity. Thus, in the MO-YSZ composite according to the embodiment of the present invention, MO-3YSZ containing 3YSZ enhances the strength of the composite and MO-8YSZ containing 8YSZ increases ionic conductivity.

Accordingly, even when the MO-YSZ composite according to the present invention has a slim thickness, it has a strength at or above a predetermined level and improved ionic conductivity.

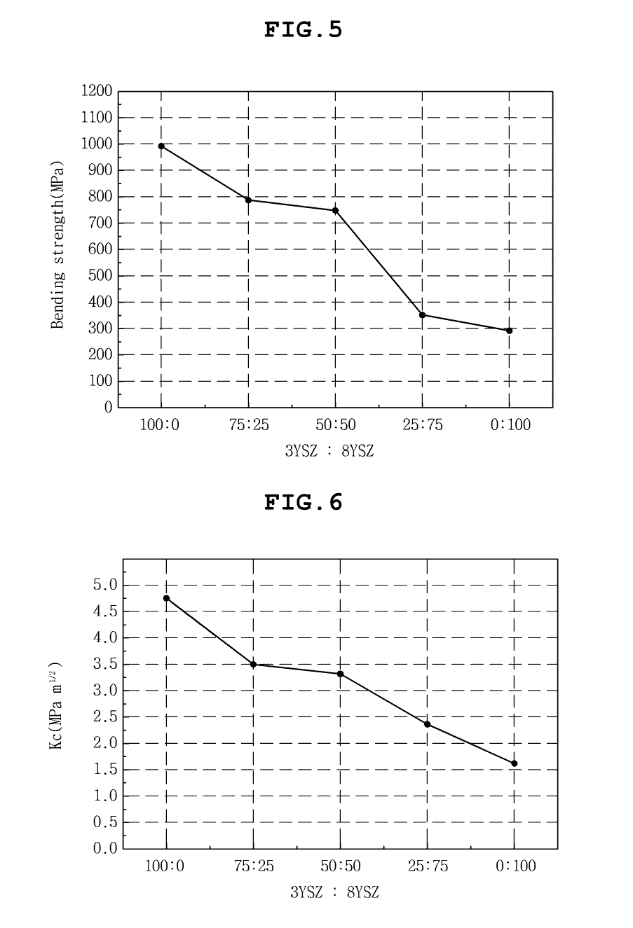

As such, the strength and ionic conductivity of the MO-YSZ composite vary depending on the weight ratio of 3YSZ and 8YSZ, which is described below with reference to FIG. 5.

FIG. 5 is a graph showing the bending strength depending on the weight ratio (wt %) of 3YSZ and 8YSZ in the MO-YSZ composite according to the embodiment of the present invention (which is very similar to bending strength of MO-3YSZ and MO-8YSZ).

In the case where 3YSZ is used in an amount of 100 wt %, the bending strength is determined to be 1000 MPa. However, because the amount of 8YSZ is 0%, ionic conductivity is very poor.

In the case of a MO-YSZ composite including 75 wt % of 3YSZ and 25 wt % of 8YSZ, its strength is comparatively maintained, and ionic conductivity is improved. Also, in the case of a MO-YSZ composite including 25 wt % of 3YSZ and 75 wt % of 8YSZ, the strength is enhanced and ionic conductivity is equivalently maintained, compared to when 8YSZ is 100 wt %.

As such, particularly favored is a MO-YSZ composite including 45˜55 wt % of 3YSZ and 55˜45 wt % of 8YSZ. This MO-YSZ composite has bending strength reduced by about 50 MPa but remarkably improved ionic conductivity compared to those of the MO-YSZ composite including 75 wt % of 3YSZ and 25 wt % of 8YSZ.

FIG. 6 is a graph showing the fracture toughness depending on the weight ratio (wt %) of 3YSZ and 8YSZ in the MO-YSZ composite according to the embodiment of the present invention (which is very similar to fracture toughness of MO-3YSZ and MO-8YSZ).

With reference to the graph of FIG. 6, results very similar to those of the graph of FIG. 5 are obtained. Thus, particularly useful is the MO-YSZ composite including 45˜55 wt % of 3YSZ and 55˜45 wt % of 8YSZ in terms of fracture toughness versus ionic conductivity.

The MO-YSZ composite as mentioned above may be manufactured as follows. Specifically, powder composed of MO-3YSZ and MO-8YSZ mixed at a predetermined weight ratio is dried along with ethanol in a zirconia jar for 24 hours. Subsequently, the powder mixture is placed in a mold (e.g. bar shape), and a green body of MO-YSZ composite is manufactured under pressure of 75 MPa and is then sintered at 1400 for 3 hours, thus obtaining the MO-YSZ composite according to the present invention.

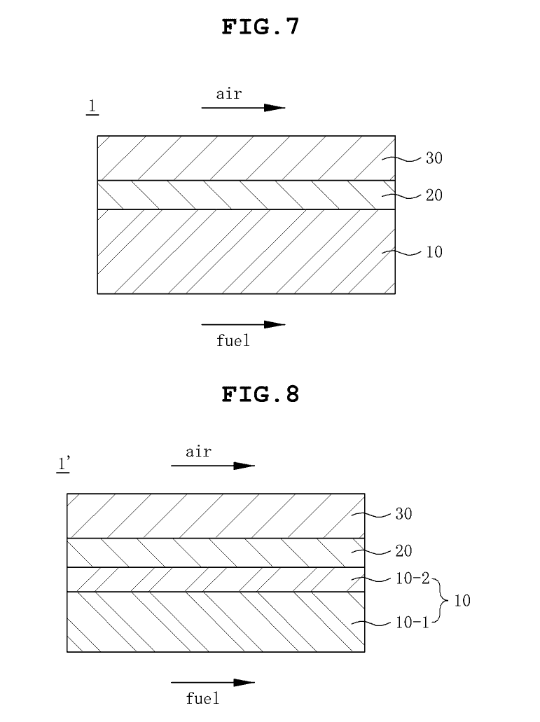

FIG. 7 is a cross-sectional view schematically showing an SOFC including the MO-YSZ composite as an anode layer, according to another embodiment of the present invention. With reference to this drawing, the SOFC according to the embodiment of the present invention is described below.

As shown in FIG. 7, the SOFC 1 includes an anode layer 10 having fuel gas permeability, an electrolyte layer 20, and a cathode layer 30 having oxygen gas permeability. The anode layer 10 is formed of the MO-YSZ composite which was mentioned above with reference to FIGS. 1 to 6. When this composite is used, strength is enhanced while ionic conductivity is maintained. Hence, even when the SOFC is used for a long period of time, the anode layer 10 may be prevented from deteriorating in terms of performance, and the thickness of the unit cell of the SOFC may be reduced. In particular, such a composite is adapted for an anode-supported SOFC.

The electrolyte layer 20 is formed on the anode layer 10. The electrolyte layer 10, which is a solid oxide electrolyte layer, has ionic conductivity lower than that of a liquid electrolyte such as an aqueous solution or molted salt, and thus reduces voltage drop due to resistance polarization. For this reason, the electrolyte layer may be formed as thin as possible. The electrolyte layer 20 is made of the same material as an ionic conductive oxide typically used for the anode layer 10, particularly favored being 8YSZ. Alternatively, samarium (Sm) or gadolinium (Gd) added ceria may be used. However, the present invention is not limited thereto.

The cathode layer 30 is formed on the electrolyte layer 20, and is permeable to oxygen gas. Typically, the cathode layer 30 may have strontium (Sr) added lanthanum (La)-manganese (Mn) oxide (La_{1-X}SrₓMnO₃: hereinafter abbreviated to LSM) having a perovskite structure (ABO3, A=rare earth and alkaline earth metal, B=transition metal, O=oxygen), or an LSM/YSZ composite. However, the present invention is not limited thereto.

The SOFC 1 according to the present invention, which includes the anode layer 10, the electrolyte layer 20 and the cathode layer 30, may be manufactured into any shape such as a planar shape, a cylindrical shape, etc., and is not limited to fuel cells having specific shapes.

FIG. 8 is a cross-sectional view schematically showing an SOFC including the MO-YSZ composite as a support layer of an anode layer, according to a further embodiment of the present invention. With reference to this drawing, the SOFC is described below. Description of constituents which are the same as the constituents described in FIG. 7 is omitted.

The SOFC 1′ of FIG. 8 includes an anode layer 10 having a support layer 10-1 and a functional layer 10-2.

The support layer 10-1 should be imparted with mechanical properties because it functions as a support of a multilayered unit cell and should satisfy electrochemical properties required for the oxidation of fuel. Thus, the support layer 10-1 is made of the MO-YSZ composite as described with reference to FIGS. 1 to 6.

The functional layer 10-2 is formed on the support layer 10-1 and is in contact with the electrolyte layer 20. Specifically, the functional layer 10-2 is disposed between the support layer 10-1 and the electrolyte layer 20. The functional layer 10-2 may include MO-YSZ, particularly MO-8YSZ.

The support layer 10-1 and the functional layer 10-2 of the anode layer 10 have divided and supplemental functions. When the support layer 10-1, which has porosity adapted to improve gas permeability despite having low electrochemical activity, is used, the ions may be rapidly delivered to the proximity of the electrolyte layer. Also, in order to supplement the low electrochemical activity of the support layer, when the functional layer 10-2 is used between the support layer 10-1 and the electrolyte layer 20, activity with the electrolyte layer 20 may be improved.

As described hereinbefore, the present invention provides a MO-YSZ composite and an SOFC using the same. According to the present invention, the MO-YSZ composite has high porosity and oxygen-ion conductivity, is slim and exhibits superior strength.

Also, according to the present invention, the SOFC including the MO-YSZ composite as an anode layer or a support layer of an anode layer can be configured to be slim and can still maintain the same strength. When the fuel cell is used for a long period of time, the strength of the anode layer can be ensured while maintaining oxygen-ion conductivity, thus lengthening the mechanical lifetime of the SOFC.

Although the embodiments of the present invention regarding the MO-YSZ composite and the SOFC using the same have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A metal oxide-yttria stabilized zirconia composite, comprising:
25˜75 wt % of a metal oxide-3 mol % yttria stabilized zirconia composite; and
75˜25 wt % of a metal oxide-8 mol % yttria stabilized zirconia composite.

2. The metal oxide-yttria stabilized zirconia composite as set forth in claim 1, wherein the metal oxide-yttria stabilized zirconia composite comprises 45˜55 wt % of the metal oxide-3 mol % yttria stabilized zirconia composite and 55˜45 wt % of the metal oxide-8 mol % yttria stabilized zirconia composite.

3. The metal oxide-yttria stabilized zirconia composite as set forth in claim 1, wherein the metal oxide of the metal oxide-yttria stabilized zirconia composite is a nickel oxide or a copper oxide.

4. A solid oxide fuel cell, comprising:
an anode layer comprising a metal oxide-yttria stabilized zirconia composite comprising 25˜75 wt % of a metal oxide-3 mol % yttria stabilized zirconia composite and 75˜25 wt % of a metal oxide-8 mol % yttria stabilized zirconia composite and having fuel gas permeability;
an electrolyte layer formed on the anode layer; and
a cathode layer which is formed on the electrolyte layer and which has oxygen gas permeability.

5. The solid oxide fuel cell as set forth in claim 4, wherein the metal oxide-yttria stabilized zirconia composite of the anode layer comprises 45˜55 wt % of the metal oxide-3 mol % yttria stabilized zirconia composite and 55˜45 wt % of the metal oxide-8 mol % yttria stabilized zirconia composite.

6. The solid oxide fuel cell as set forth in claim 4, wherein the metal oxide of the metal oxide-yttria stabilized zirconia composite of the anode layer is a nickel oxide or a copper oxide.

7. The solid oxide fuel cell as set forth in claim 4, wherein the anode layer comprises a support layer and a functional layer which is formed on the support layer and which is in contact with the electrolyte layer, in which the support layer comprises a metal oxide-yttria stabilized zirconia composite comprising 25˜75 wt % of a metal oxide-3 mol % yttria stabilized zirconia composite and 75˜25 wt % of a metal oxide-8 mol % yttria stabilized zirconia composite, and the functional layer comprises metal oxide-yttria stabilized zirconia.

8. The solid oxide fuel cell as set forth in claim 7, wherein the metal oxide-yttria stabilized zirconia composite of the support layer comprises 45˜55 wt % of the metal oxide-3 mol % yttria stabilized zirconia composite and 55˜45 wt % of the metal oxide-8 mol % yttria stabilized zirconia composite.
